(19) United States
(12) Patent Application Publication
(10) Pub. No.: US 2019/0335909 A1
(43) Pub. Date: Nov. 7, 2019

(54) LOWER EXTREMITY JACK

(71) Applicant: John Lawrence Fontana, Lafayette, LA (US)

(72) Inventor: John Lawrence Fontana, Lafayette, LA (US)

(21) Appl. No.: 15/971,355

(22) Filed: May 4, 2018

(51) Int. Cl. A47C 16/02; A47C 7/50

(52) U.S. Cl. CPC A47C 16/025; A61H 2205/10; A47C 7/506

(57) ABSTRACT

A portable, reusable appendage supporting device is provided for elevating the leg of bed-ridden patients for evaluation and treatment to their lower extremities. The appendage lifting device provide a base unit providing a telescopic pole connecting a support element for the patient's appendage. The telescopic pole enables selective elevational adjustment of the supporting element. The present invention also includes a pivot connection and locking mechanism interconnecting the support element and the telescopic pole, so that the orientation of the supporting element can be further rotationally adjusted and secured during use.

### BACKGROUND OF THE INVENTION

The present invention relates to medical devices and, more particularly, to a portable, reusable appendage supporting device for elevating the leg of a bed-ridden patient for evaluation and treatment to their lower extremities.

Current medical solutions for supporting the appendages of bed-bound patients during a medical examination requires two or three medical clinicians to assist, evaluate and treat injuries to the lower extremities. Typically, one or two staff members are required to manually elevate and hold the patient's leg up for an extended period of time while the physician or nurse evaluates and treats the injury. Manual lifting and holding of the extremity over an extended time can cause the patient to feel increasing pain and discomfort. Moreover, such manual lifting and holding of a lower extremity for an extended period of time becomes heavy and unstable, requiring the staff to place the extremity down on the bed only to resume manually supporting the appendage, sometimes repeatedly, until the treatment or evaluation is completed. Such sub-optimal ergonomic dynamics applies strain and stress to muscles of the neck and back of the staff, resulting in their own muscle strain/injuries. Furthermore, this current approach drains human capital in many medical facilities that are already short on peoplepower.

As can be seen, there is a need for a portable, reusable appendage supporting device for elevating the leg of bed-ridden patients for evaluation and treatment to their lower extremities. The appendage lifting device is adapted to raise a patient's leg up to 13 inches off a supporting surface, such as a bed, that the patient is required to lay supine. Thus, the present invention allows the medical clinician ample time and space to evaluate and treat chronic and acute wounds of the lower extremity (foot/leg) in a stabilized, secure manner with minimal disruption, manipulation, and discomfort to the patient, decreasing the pain of the patient while reducing potential back and neck injuries of the medical clinicians.

### SUMMARY OF THE INVENTION

In one aspect of the present invention, an appendage supporting device for elevating the leg of a bed-ridden patient for evaluation and treatment to their lower extremities, including a base unit; a telescopic post extending from the base unit; a pivot connection attached to a distal end of the telescopic post; and a support element pivotably connected to the pivot connection so that the support element is rotatable among a plurality of orientations about a longitudinal axis extending from said distal end.

In another aspect of the present invention, the appendage supporting device for elevating the leg of a bed-ridden patient for evaluation and treatment to their lower extremities, including a base unit comprising a plurality of supporting members extending from a base plate; an elastic stopper attached to the distal end of each supporting member; a stationary component extending from said base plate; an adjustable component positionable between a plurality of elevations along the stationary component relative to the base plate; a rod extending along a longitudinal axis from a distal end of the adjustable component; a bearing block adapted to rotate about the rod among a plurality of orientations relative to the base plate; a locking mechanism configured to move between an unlocked condition, allowing the bearing block to selectively rotate, and a locked condition securing the bearing block at one of the plurality of orientations; and a support element pivotably connected to the pivot connection so that the support element is rotatable among a plurality of orientations about a longitudinal axis extending from said distal end.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in a first orientation;

FIG. 2 is a perspective view of an exemplary embodiment of the present invention, shown in a second orientation;

FIG. 3 is a side elevation view of an exemplary embodiment of the present invention, shown in the first orientation;

FIG. 4 is a side elevation view of an exemplary embodiment of the present invention, shown in the second orientation;

FIG. 5 is a rear elevation view of an exemplary embodiment of the present invention, shown in the first orientation; and

FIG. 6 is a rear elevation view of an exemplary embodiment of the present invention, shown in the second orientation.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a portable, reusable appendage supporting device for elevating the leg of bed-ridden patients for evaluation and treatment to their lower extremities. The appendage lifting device provide a base unit providing a telescopic pole connecting a support element for the patient's appendage. The telescopic pole enables selective elevational adjustment of the supporting element. The present invention also includes a pivot connection and locking mechanism interconnecting the support element and the telescopic pole, so that the orientation of the supporting element can be further rotationally adjusted and secured during use.

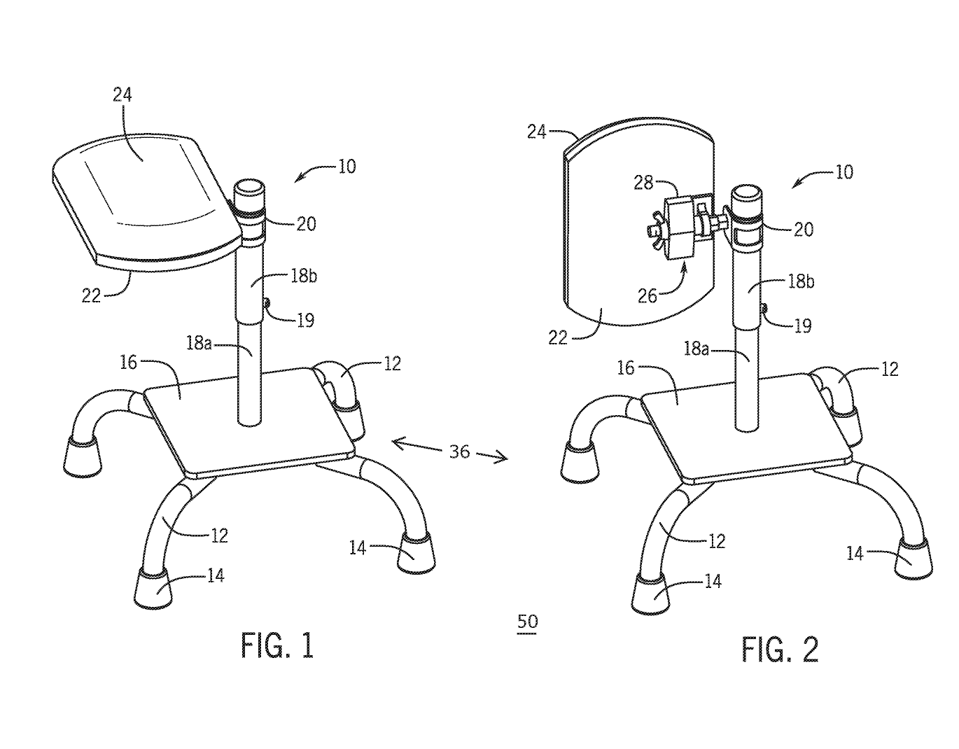

Referring to FIGS. 1 through 6, the present invention may include a medical device 10 for lifting and continuously supporting an appendage of a human user at various orientations. The medical device 10 may include a support element 22 for said appendage, wherein the support unit is pivotally connected to a telescopic post 18, which in turn is connected to a base unit 36.

Starting from the floor up, and referring to FIGS. 1 and 2, the base unit 36 may include a base plate 16 spaced apart from a supporting surface 50 by a plurality of supporting member 12 interconnecting the base plate 16 to the supporting surface 50. Each supporting member 12 may include lo-skid or no-skid elements 14. In certain embodiments, the plurality of supporting members 12 may be 3.5-inch sturdy legs terminating in elastic stoppers 14, wherein the legs 12 support the durable (e.g., made from metallic material or the like) base plate 16.

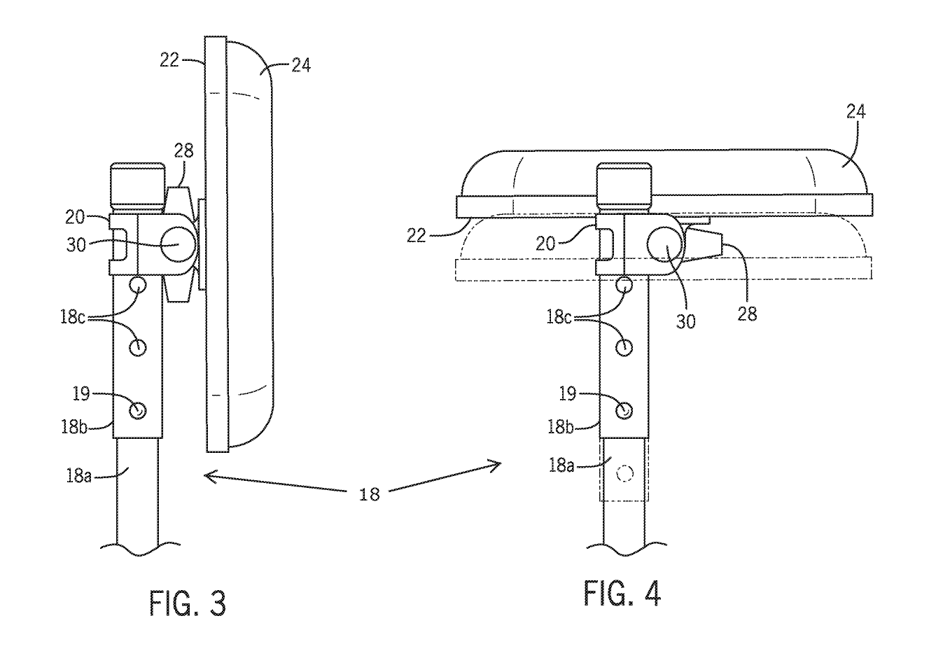

Referring to FIGS. 3 and 4, telescopic post 18 interconnects the base unit 36 and the supporting element 22. The telescopic post 18 may provide an adjustable component 18b dimensioned and adapted to slidably receive a stationary component 18a, the stationary component 18a perpendicularly extending from the base unit 36. In certain embodiments, the stationary component 18a may be welded to the base unit 36. The telescopic post 18 can be selectively moved between a plurality of elevations by engaging a detent element 19 with one of a plurality of elevational holes 18c aligned and communicating the adjustable component 18b and the stationary component 18a. In certain embodiments, the telescopic post 18 may include four elevational holes 18c holes approximately one inch from each other allowing the adjustable component 18b to be raise or lower by the detent element 19 inside the stationary component 18a. The adjustable component 18b may slide up and down upon the stationary component 18a. In certain embodiments, the stationary component 18a may be approximately six inches in length so that when the sliding adjustable component 18b is at the lowest level (sitting at the base plate 16 and or the lowest detent element 19/elevational hole 18c) the support element 22 is approximately 5.5 inches from the base plate 16. When the detent element 19 is set to its highest level the support element 22 may be approximately 10 inches high from the base plate 16.

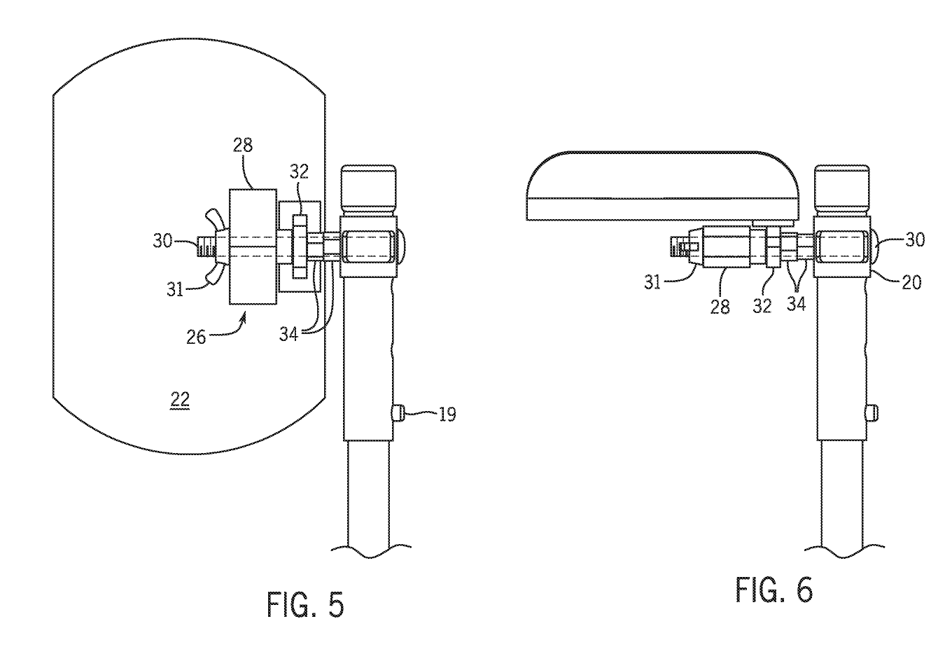

Referring to FIGS. 5 and 6, a saddle clamp 20 may interconnect a portion of the adjustable component 18b and a pivotal connection 26 of the support element 22. The pivotal connection 26 may include a rod 30 extending from the saddle clamp 20 and a pivot element 32 pivotably attached/rotatably connected to the rod 30. In certain embodiments, the rod 30 may be a carriage bolt and the pivot element 32 a bearing block. The pivotal connection 26 may also include a locking mechanism providing a swivel unit 26, an angle adjustment block 28, a plurality of stops 34 and a wingnut 31 operatively associated with the rod 30. The pivot connection 26 can be positioned between an unlocked condition, allowing swiveling of the support element 22, and a locked condition, selectively securing the support element 22 at a desired orientation. The pivot connection 26 can be secured and unsecured in various orientations through tightening and untightening, respectively, the wing nut 31 against the angle adjustment block 28, with along with the stops 34 sandwiches the pivot element 32 in the locked condition.

The pivot connection 26 enables the interconnected support element 22 rotate about a longitudinal axis defined by the rod 30. Furthermore, the support element 22 can be selectively secured through a range of 360 degrees relative to the supporting surface 50. For example, the support element 22 can either remain in a neutral horizontal position, tilted into a vertical position swiveling from 0 degree to 180 degrees, and so forth, as illustrated in FIGS. 5 and 6, respectively. In such embodiments, when the supporting member 12 are on the support surface 50, the support element 22 may be 9.5 inches high at the lowest elevational hole 18c. If the detent element 19 is set to its highest elevational hole 18c, the support element 22 may be at 13.5 inches above the supporting surface 50. The support element 22 may be approximately 10×6 inches and provide a pad 24 along one surface as illustrated in the drawings.

A method of using the present invention may include the following. The medical device 10 disclosed above may be provided. A user may manually set the telescopic post 18 at a desired elevation for transferring an appendage of a bed-ridden patient from the bed to the supporting element 24. The supporting element 24 may be pivoted to a desire orientation about said longitudinal axis. The desired orientation may be adjusted selectively multiple times between first transferring said appendage and multiple times during examination and treatment of the relevant injury as well as during post-examination cleaning and storage. Such selective adjustment is done through manipulation of the pivotal connection 26 and said locking mechanism. The present invention alleviates the many problems involved: elevating the affected limb and keeping it in a stable secured position that is comfortable for the patent; and for the clinician, preventing dysfunctional ergonomic posture when conducting the evaluation and treatment.

It should be understood, of course, that the foregoing relates to exemplary embodiments of the invention and that modifications may be made without departing from the spirit and scope of the invention as set forth in the following claims.

What is claimed is:

1. A device, comprising:
a base unit;
a telescopic post extending from the base unit;
a pivot connection attached to a distal end of the telescopic post; and
a support element pivotably connected to the pivot connection so that the support element is rotatable among a plurality of orientations about a longitudinal axis extending from said distal end.

2. The device of claim 1, wherein the base unit further comprises a plurality of supporting members extending from a base plate.

3. The device of claim 2, further comprising an elastic stopper attached to the distal end of each supporting member.

4. The device of claim 2, wherein the telescopic post further comprises a stationary component and an adjustable component, the stationary component extends from said base plate, and wherein the adjustable component is positionable between a plurality of elevations along the stationary component relative to the base plate.

5. The device of claim 1, wherein the pivot connection further comprises a rod extending along the longitudinal axis from said distal end, and a bearing block adapted to rotate about the rod.

6. The device of claim 5, further comprising a locking mechanism configured to move between an unlocked condition, allowing the support element to selectively rotate, and a locked condition securing the support element at one of the plurality of orientations.

7. The device of claim 6, wherein the locking mechanism further comprises a wing nut, a plurality of stop nuts and an angle adjusting block operatively associate with the rod.

8. The device of claim 1, further comprising a pad attached along a surface of the support element.

9. The device of claim 1, wherein said distal end positionable between approximately 5.5 and ten inches above the base unit through the plurality of elevations.

10. A device, comprising:
a base unit comprising a plurality of supporting members extending from a base plate;
an elastic stopper attached to the distal end of each supporting member;
a stationary component extending from said base plate;
an adjustable component positionable between a plurality of elevations along the stationary component relative to the base plate;
rod extending along a longitudinal axis from a distal end of the adjustable component;
a bearing block adapted to rotate about the rod among a plurality of orientations relative to the base plate;
a locking mechanism configured to move between an unlocked condition, allowing the bearing block to selectively rotate, and a locked condition securing the bearing block at one of the plurality of orientations; and
a support element pivotably connected to the pivot connection so that the support element is rotatable among a plurality of orientations about a longitudinal axis extending from said distal end.

11. The device of claim 10, wherein the locking mechanism further comprises a wing nut, a plurality of stop nuts and an angle adjusting block operatively associate with the rod.

12. The device of claim 10, further comprising a pad attached along a surface of the support element.

13. The device of claim 10, wherein said distal end positionable between approximately 5.5 and ten inches above the base unit through the plurality of elevations.
